(19) United States
(12) Patent Application Publication
(10) Pub. No.: US 2024/0125441 A1
(43) Pub. Date: Apr. 18, 2024

(54) LANDING PAD, STREET LIGHT HAVING THE SAME, AND LANDING PAD USING METHOD

(71) Applicant: LEOTEK CORPORATION, Taipei City (TW)

(72) Inventor: Tsan-Li CHIU, Taipei City (TW)

(21) Appl. No.: 18/125,636

(22) Filed: Mar. 23, 2023

Related U.S. Application Data
(60) Provisional application No. 63/416,991, filed on Oct. 18, 2022.

(30) Foreign Application Priority Data
Dec. 13, 2022 (CN) 202211604365.6

(51) Int. Cl. F21S 8/08; B60L 53/12; B64C 39/02

(52) U.S. Cl. CPC F21S 8/086; B60L 53/12; B64C 39/024; F21W 2131/103

(57) ABSTRACT

A landing pad is provided. The landing pad includes a first body, a second body, an elastic component, and a fastening component. The first body includes a pad portion and a first coupling portion. The pad portion is configured for landing of a drone. The first coupling portion is connected to the pad portion. The second body includes a mounting portion and a second coupling portion. The mounting portion is configured for mounting to a position to be mounted. The second coupling portion is connected to the mounting portion. The second coupling portion is configured for coupling with the first coupling portion. The elastic component is disposed between the first coupling portion and the second coupling portion. The fastening component is configured for combination of the first coupling portion, the second coupling portion, and the elastic component.

This application claims the benefit of U.S. provisional application Ser. No. 63/416,991, filed Oct. 18, 2022, and People's Republic of China application Serial No. 202211604365.6, filed Dec. 13, 2022, the subject matters of which are incorporated herein by references.

### TECHNICAL FIELD

This disclosure relates to a landing pad, a street light having the same, and a landing pad using method. More particularly, this disclosure relates to a landing pad for a drone, a street light having the same, and a landing pad using method.

### BACKGROUND

Drones have become quite popular. Nowadays, drone performances are often seen at large-scale celebrations as a way of air shows other than fireworks. In addition, drones are used for private purposes, too. For example, researchers or self-media workers commonly obtain data of bird's-eye view data using drones. Drones can also be used in the delivery of small objects. As such, it will be beneficial to provide more pads for the drones to land on.

### SUMMARY

This disclosure provides a landing pad for a drone, which is easy to use and can be simply attached to existing buildings, public facilities, and/or the like. This disclosure also provides a street light having the same and a landing pad using method.

A landing pad according to the disclosure comprises a first body, a second body, an elastic component, and a fastening component. The first body comprises a pad portion and a first coupling portion. The pad portion is configured for landing of a drone. The first coupling portion is connected to the pad portion. The second body comprises a mounting portion and a second coupling portion. The mounting portion is configured for mounting to a position to be mounted. The second coupling portion is connected to the mounting portion. The second coupling portion is configured for coupling with the first coupling portion. The elastic component is disposed between the first coupling portion and the second coupling portion. The fastening component is configured for combination of the first coupling portion, the second coupling portion, and the elastic component.

A street light according to the disclosure comprises a pole portion, a lamp portion, and the landing pad according to the disclosure. The lamp portion is connected to the pole portion. The landing pad is mounted on the lamp portion through the mounting portion.

A landing pad using method according to the disclosure comprises following steps. First, the landing pad according to the disclosure is mounted on a lamp portion of a street light. Then, the pad portion is leveled at an angle rotatable state of the landing pad. Thereafter, the fastening component is fastened such that the landing pad is at a fixed state.

### BRIEF DESCRIPTION OF THE DRAWINGS

FIG. 1 illustrates a street light of the disclosure.

FIGS. 2A-2E illustrate a landing pad of the disclosure.

FIGS. 3A-3B illustrate a lamp portion of a street light used in conjunction with the landing pad of the disclosure.

FIGS. 4A-4B illustrate a drone used in conjunction with the landing pad of the disclosure.

FIGS. 5A-5B to FIGS. 7A-7B illustrate the use of the landing pad of the disclosure.

FIG. 8 illustrates another landing pad of the disclosure.

FIGS. 9A-9B illustrate some steps of a landing pad using method of the disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

The disclosure will be described more fully hereinafter. It should be understood that the following description and accompanying drawings are provided for illustrative only, and should not result in a limit. For example, when one element is described to be “connected to” another element, the element may be connected to the another element directly or through one or more intervening elements, unless otherwise specified. It is contemplated that the elements and features of one embodiment can be beneficially incorporated in another embodiment without further recitation.

In the disclosure, a landing pad is provided. The landing pad comprises a first body, a second body, an elastic component, and a fastening component. The first body comprises a pad portion and a first coupling portion. The pad portion is configured for landing of a drone. The first coupling portion is connected to the pad portion. The second body comprises a mounting portion and a second coupling portion. The mounting portion is configured for mounting to a position to be mounted. The second coupling portion is connected to the mounting portion. The second coupling portion is configured for coupling with the first coupling portion. The elastic component is disposed between the first coupling portion and the second coupling portion. The fastening component is configured for combination of the first coupling portion, the second coupling portion, and the elastic component.

The disclosure also provides a street light. The street light comprises a pole portion, a lamp portion, and the landing pad according to the disclosure. The lamp portion is connected to the pole portion. The landing pad is mounted on the lamp portion through the mounting portion.

It should be understood that while the landing pad is mounted to a street light in the following examples, the landing pad of the disclosure may be mounted to other buildings or public facilities, without particular limits.

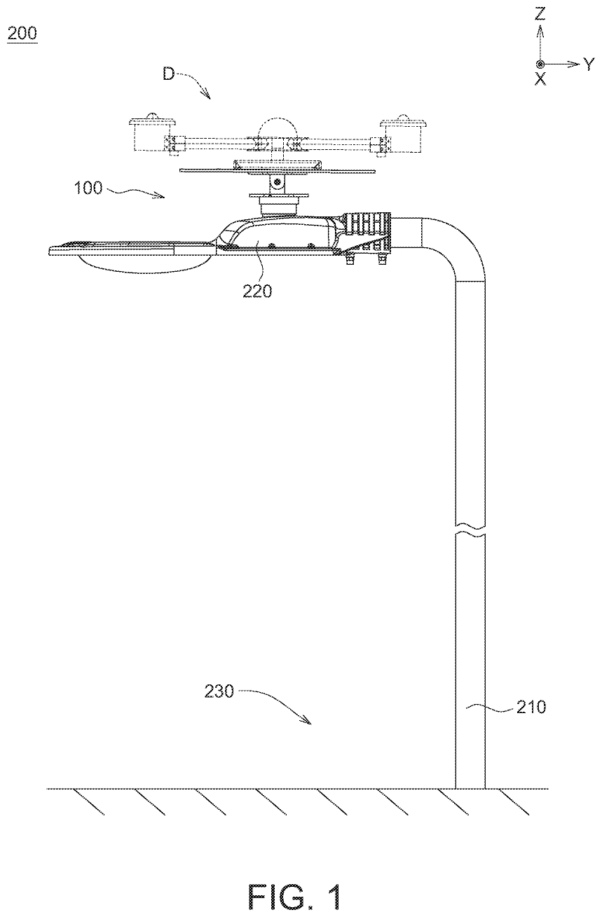

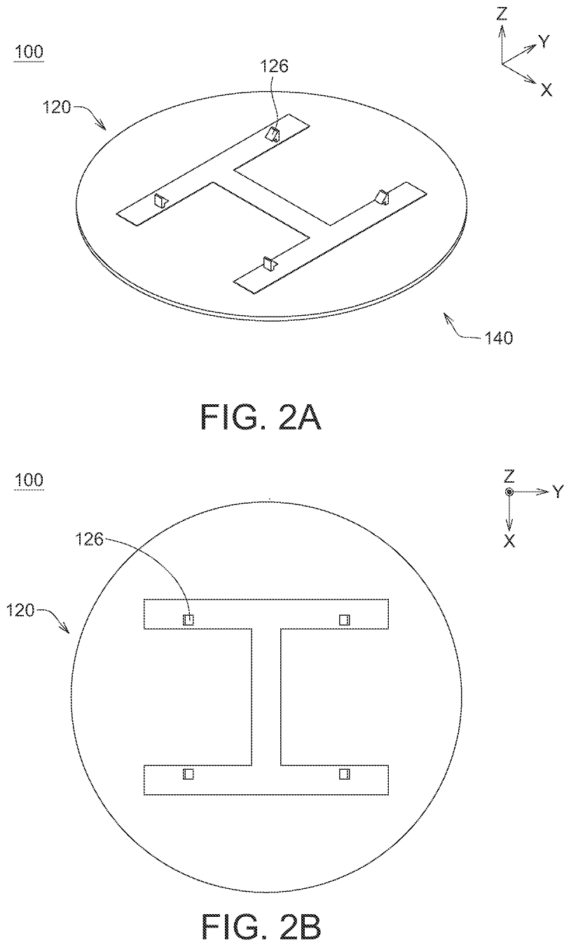

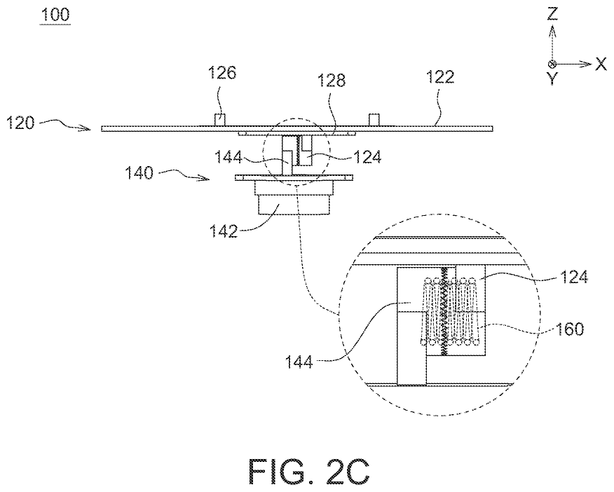

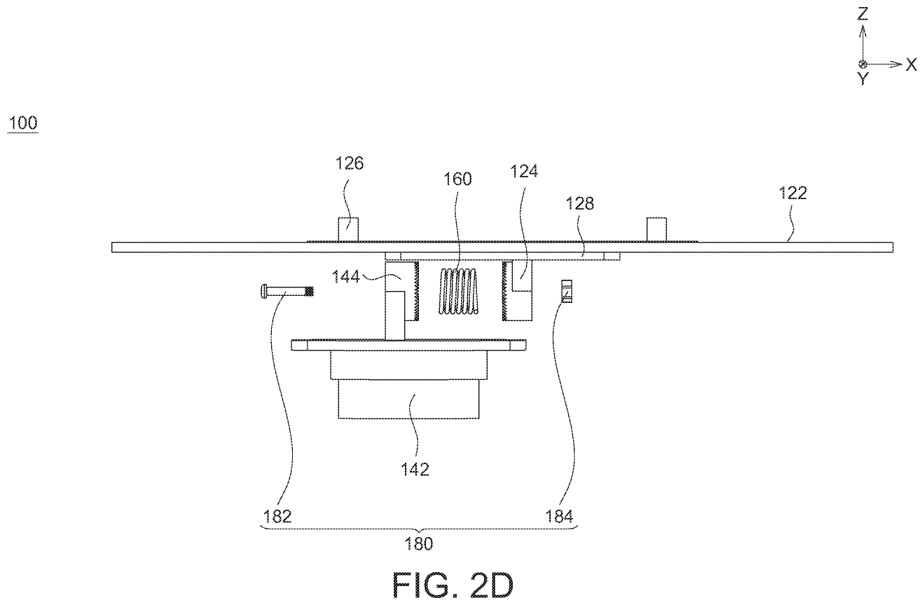

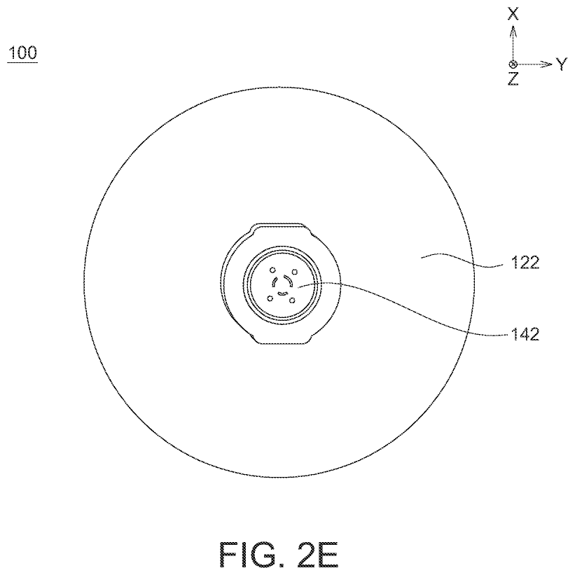

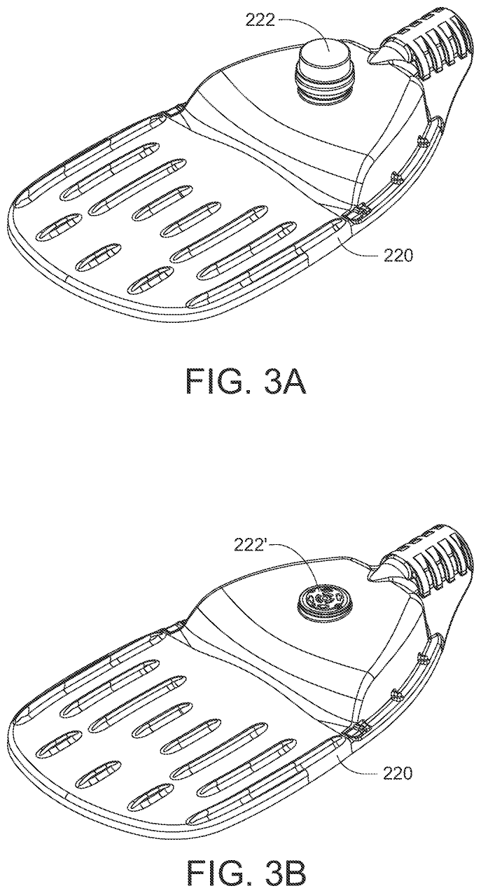

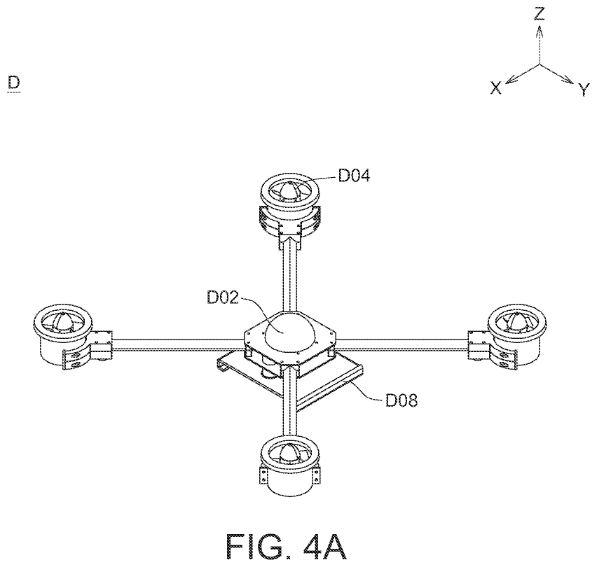

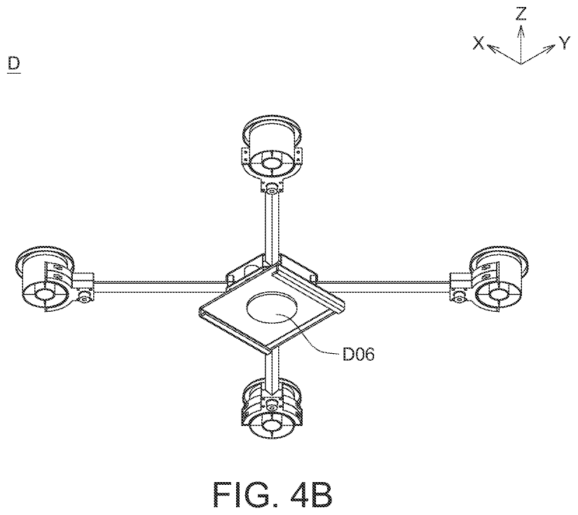

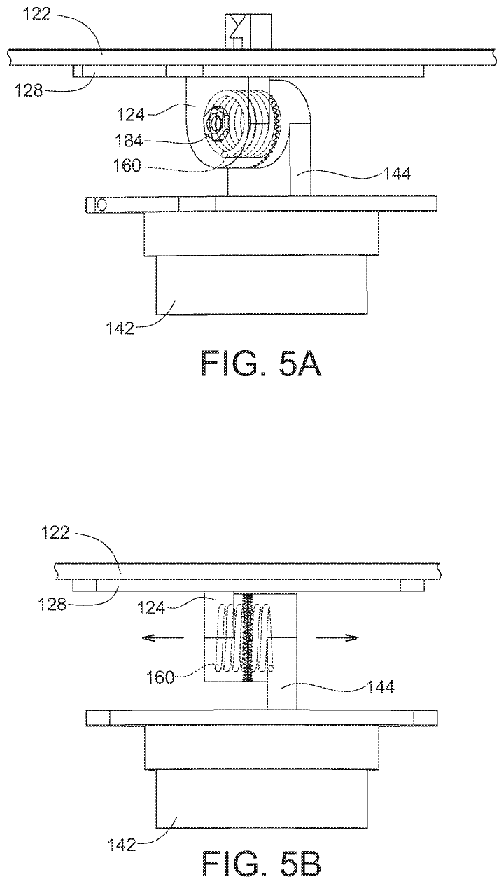

Hereinafter, the details of the landing pad of the disclosure and the street light having the same will be provided with reference to FIG. 1 to FIGS. 7A-7B. Specifically, FIG. 1 illustrates a street light of the disclosure. FIG. 1 shows a landing pad 100 according to the disclosure and a street light 200 having the same, and exemplarily shows a drone D landing on the landing pad 100 for assisting understanding of the application of the landing pad 100 and the street light 200. FIGS. 2A-2E illustrate the landing pad 100 of the disclosure. FIGS. 3A-3B illustrate a lamp portion of the street light 200 used in conjunction with the landing pad 100 of the disclosure. FIGS. 4A-4B illustrate the drone D used in conjunction with the landing pad 100 of the disclosure. The drone D can comprise a 360° camera D02, a helix device D04, a wireless charging device D06, and a wireless charging holder D08, without particular limits. The drone D may also be any other commercially available or subsequently developed drones. In order to avoid obscuring the disclosure, other details of the drone D are omitted herein. FIGS. 5A-5B to FIGS. 7A-7B illustrate the use of the landing pad of the disclosure. For clarity, the elements may not be drawn to scale. In addition, some elements and/or reference numerals may be omitted in some drawings.

As shown in FIG. 1, the street light 200 according to the disclosure comprises a pole portion 210, a lamp portion 220, and the landing pad 100. The lamp portion 220 is connected to the pole portion 210. The landing pad 100 is mounted on the lamp portion 220 through a mounting portion of the landing pad 100. Since the landing pad 100 is disposed on the lamp portion 220 of the street light 200, the space occupied by the landing pad 100 is a space that is generally unusable, and thus the landing pad 100 will not affect people's daily lives. In some embodiments, the street light 200 can further comprise a storage space 230. The storage space 230 is below the lamp portion 220, and provided for the drone D. In such conditions, people can simply walk to the street light to place or pick up the goods, and use the drone D to deliver the goods. The storage space 230 can be defined by the pole portion 210 and the lamp portion 220, and it can be on the pole portion 210, directly under the lamp portion 220, or oblique below the lamp portion 220, without particular limits. It can be understood that, except for the landing pad 100 and its corresponding elements, the street light 200 is substantially the same as typical street lights. In order to avoid obscuring the disclosure, other details of the street light 200 are omitted herein.

As shown in FIGS. 2A-2E, the landing pad 100 according to the disclosure comprises a first body 120, a second body 140, an elastic component 160, and a fastening component 180. The first body 120 comprises a pad portion 122 and a first coupling portion 124. The pad portion 122 is configured for landing of the drone D. The first coupling portion 124 is connected to the pad portion 122. The second body 140 comprises a mounting portion 142 and a second coupling portion 144. The mounting portion 142 is configured for mounting of the landing pad 100. The second coupling portion 144 is connected to the mounting portion 142. The second coupling portion 144 is configured for coupling with the first coupling portion 124. The elastic component 160 is disposed between the first coupling portion 124 and the second coupling portion 144. The fastening component 180 is configured for combination of the first coupling portion 124, the second coupling portion 144, and the elastic component 160. For example, the fastening component 180 can pass through the first coupling portion 124, the second coupling portion 144, and the elastic component 160 so as to fasten the first coupling portion 124, the second coupling portion 144, and the elastic component 160.

Specifically, the pad portion 122 of the first body 120 provides a pad for the drone D to land on. In some embodiments, the first body 120 can further comprise a securing component 126 disposed on the pad portion 122. The securing component 126 is configured for fastening the drone D on the pad portion 122. As such, falling of the drone D due to wind, rain, or animal attacks can be further prevented. One or more securing components 126 can be used. When the first body 120 have a plurality of securing components 126, the securing components 126 can be disposed on the pad portion 122 in a symmetrical manner. According to some embodiments, the securing component 126 can move forwards or backwards and/or deform on the pad portion 122. When the drone D lands on the pad portion 122, the force of the drone D can push away the securing component 126, and then the securing component 126 can fix the drone D by the back force provided by its material properties or mechanism design. For example, the securing component 126 can be a snap made of an elastic material and/or used with a spring.

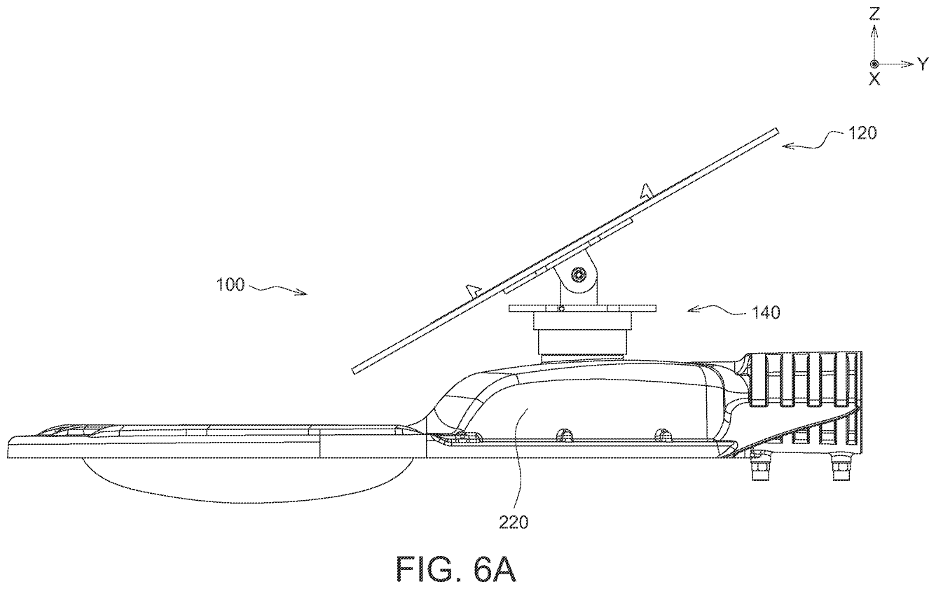

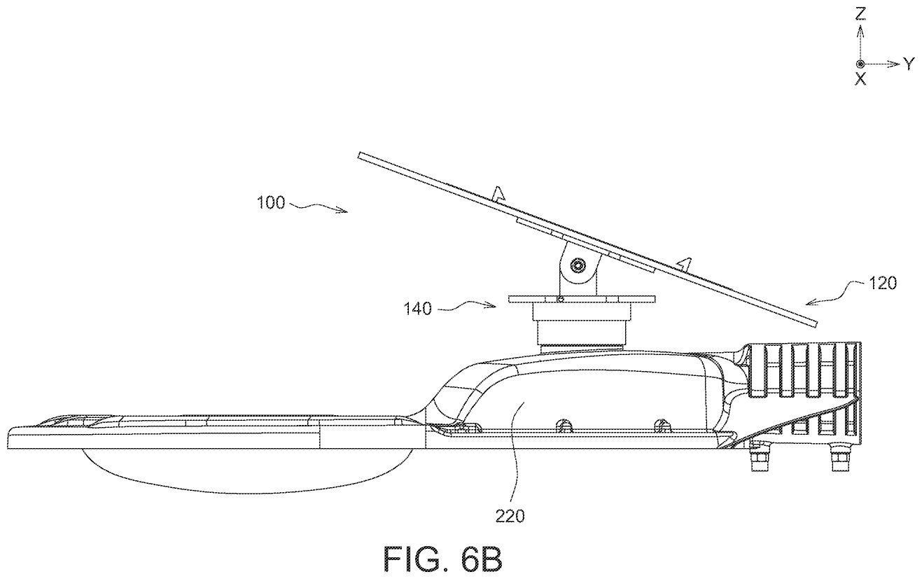

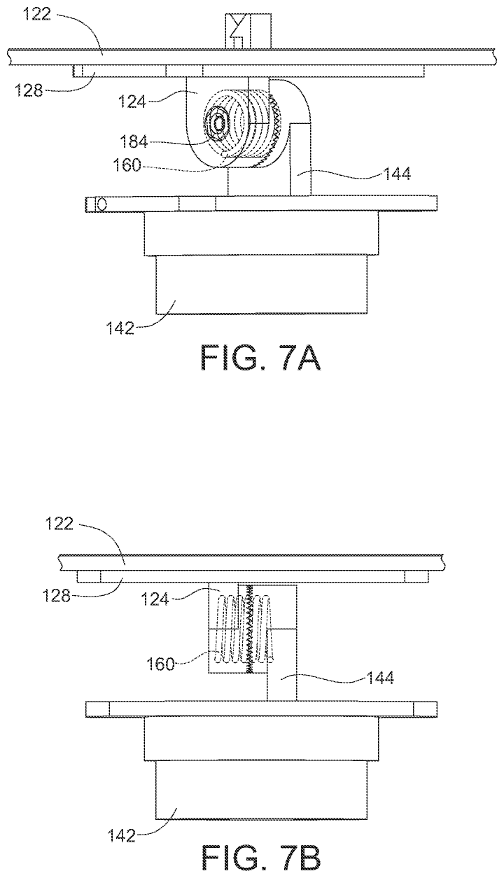

The first coupling portion 124 is coupled with the second coupling portion 144 of the second body 140. More specifically, the first coupling portion 124 and the second coupling portion 144 are coupled to each other in a manner that they can be released from and thus rotate with respect to each other and can be fastened with and thus be fixed to each other through the elastic component 160 and the fastening component 180. For example, the first coupling portion 124 and the second coupling portion 144 can comprise gears. The elastic component 160 can be a spring. The fastening component 180 can comprise a screw 182 and a nut 184. As shown in FIGS. 5A-5B, when the nut 184 and the screw 182 are not locked, the spring as an intervening element between the two gears provides an outward force caused by the compression as indicated by the arrow, ensuring that there is a gap between the two gears, such that the first coupling portion 124 and the second coupling portion 144 can rotate with respect to each other, and thus the first body 120 and the second body 140 can rotate with respect to each other. For example, in the use condition as shown in FIG. 6A, the first body 120 rotates to left with relative to the second body 140, and an angle with the opening towards the right side of the drawing is formed. In the use condition as shown in FIG. 6B, the first body 120 rotates to right with relative to the second body 140, and an angle with the opening towards the left side of the drawing is formed. As shown in FIGS. 7A-7B, when the nut 184 and the screw 182 are locked, the gears and the spring fastened by them can no longer move, there is no gap between the two gears even though the spring is still compressed, such that the first coupling portion 124 and the second coupling portion 144 cannot rotate with respect to each other, and thus the first body 120 and the second body 140 are fixed to and cannot rotate with respect to each other.

Herein, an “angle rotatable state” of the landing pad 100 is referred to a state in which the first coupling portion 124 and the second coupling portion 144 are loosened to allow rotation with respect to each other and thus make the first body 120 and the second body 140 rotatable to each other, wherein said angle is referred to the included angle between the first body 120 and the second body 140. As long as the first coupling portion 124 and the second coupling portion 144 are loosened from each other, the angle between the first body 120 and the second body 140 can be adjusted without using additional tools, such that the first body 120 can be rotated to a desired angle with respect to the second body 140. For example, regardless of a tilt angle of the lamp portion 220, the pad portion 122 of the first body 120 can be adjusted to be horizontal. When the pad portion 122 is rotated to a desired angle, the first coupling portion 124 and the second coupling portion 144 can be fastened (for example, locked) by the fastening component 180 for fixing. Herein, a “fixed state” of the landing pad 100 is referred to a state in which the first coupling portion 124 and the second coupling portion 144 are fastened and fixed to each other and thus make the first body 120 and the second body 140 are fixed to each other.

According to some embodiments, the first body 120 can further comprise a wireless charging device 128 disposed in or under the pad portion 122. As such, when the drone D stops on the pad portion 122, the drone D can be charged through the induction between the wireless charging device 128 and the wireless charging device D06. In addition, in some embodiments, the pad portion 122 can be functioned as a solar panel. As such, when there is not drone D stopping thereon, the pad portion 122 can receive sunlight and charge the wireless charging device 128 and even the street light 200.

The mounting portion 142 of the second body 140 is configured for mounting to other facilities, such as a street light. For example, As shown in FIG. 3A, the lamp portion 220 of the street light 200 according to the disclosure can have a corresponding mounting portion 222 disposed on its upper side (herein, it referrers to the side opposite to the light-emitting side) for assembly with the mounting portion 142 of the landing pad. In this disclosure, the mounting portion 142 and the mounting portion 222 can be combined through a simple mechanical design, and the mounting portion 142 can be assembled to the mounting portion 222 without using additional tools. Such means is not only convenient for installation, but also saves time. According to some embodiments, a mounting portion 222′ as shown in FIG. 3B can be used. The mounting portion 222′ further provides an electrical connection. In such conditions, the pad portion 122 functioned as a solar panel can receive sunlight and charge the street light 200. Then, the street light 200 can further supply power to the drone D through the wireless charging device 128 when the drone D stops on the landing pad 100.

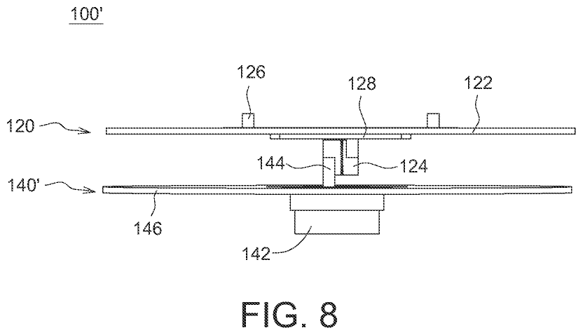

It can be understood that the landing pad of the disclosure can be further modified according to usage requirements and the like. For example, referring to FIG. 8, in another landing pad 100′, the second body 140′ further comprise an auxiliary plate 146 disposed between the mounting portion 142 and the second coupling portion 144. The auxiliary plate 146 can facilitate manual assembly. In some further embodiments, the auxiliary plate 146 is designed to provide other additional functions, which will not be described herein.

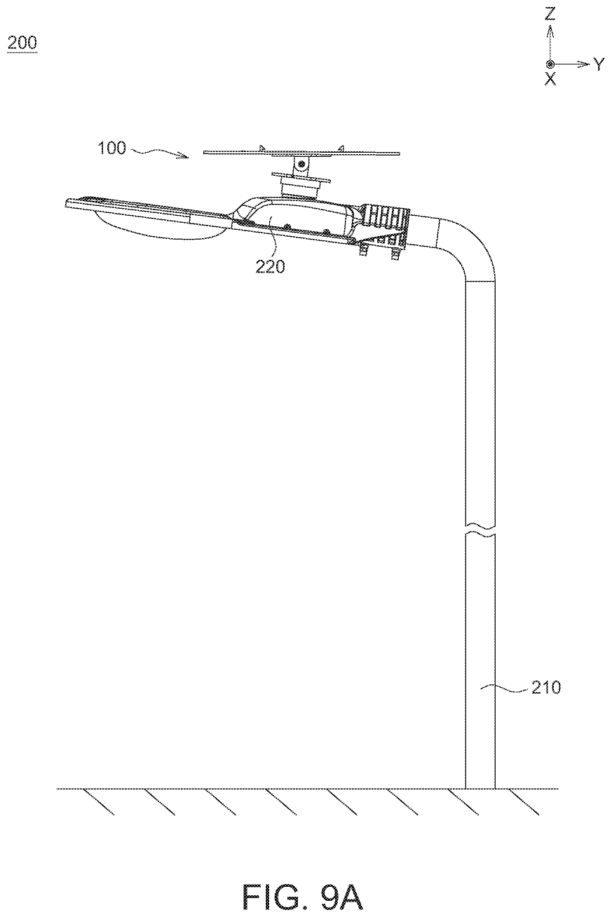

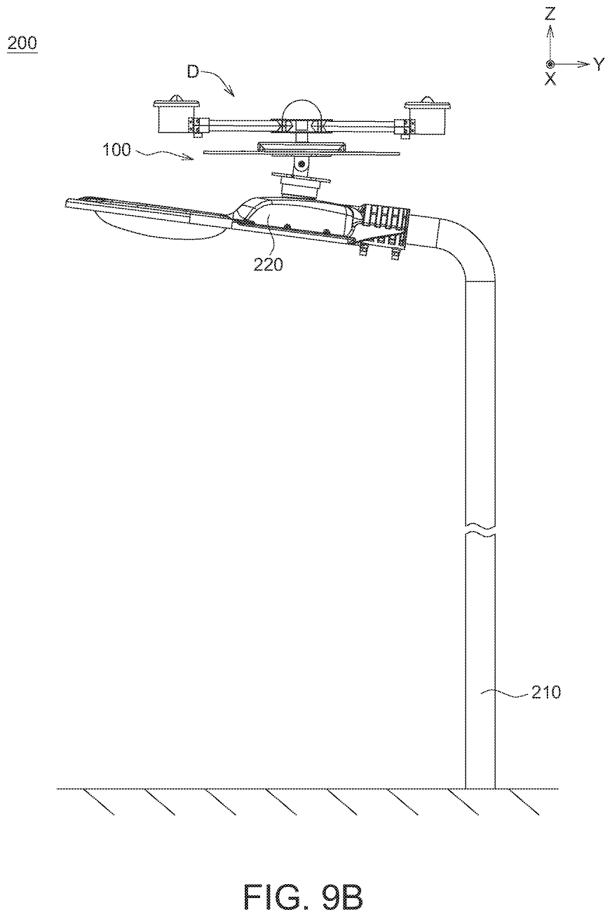

The disclosure further provides a landing pad using method, which comprises following steps. First, as shown in FIG. 9A, the landing pad 100 according to the disclosure is mounted on the lamp portion 220 of the street light 200. The pad portion 122 is leveled at an angle rotatable state of the landing pad 100. Then, the fastening component 180 is fastened such that the landing pad 100 is at a fixed state. Thereafter, as shown in FIG. 9B, the landing pad using method of the disclosure can further comprise landing the drone D on the leveled pad portion 122. Sometimes, the angle of the landing pad 100 will change due to the influence of environment or external force. In such conditions, the fastening component 180 can be loosened, and the pad portion 122 can be leveled again. Then, the fastening component 180 can be retightened. In other words, when the angle of the pad portion 122 needs to be readjusted, the step of leveling the pad portion 122 at the angle rotatable state of the landing pad 100 and the step of fastening the fastening component 180 such that the landing pad 100 is at the fixed state can be performed again. According to some embodiments, the landing pad using method of the disclosure can further comprise can further comprise charging the drone D with the landing pad 100. According to some embodiments, the landing pad using method of the disclosure can further comprise can further comprise charging the street light 200 with the landing pad 100.

In summary, the disclosure provides a landing pad for a drone, which is easy to use and can be simply attached to existing buildings and/or public facilities, such as a street light. The landing pad of the disclosure can be assembled and performed the angle adjustment without using additional tools, the assembly is convenient and the time saving, and the assembly will not be affected even if the facility surface to be assembled is not horizontal (for example, a street light typically has a tilt angle). In some embodiments, the landing pad of the disclosure can charge the drone and even the street light. In some embodiments, the landing pad of the disclosure comprises a securing component, which is beneficial for preventing falling of the drone due to wind, rain, or animal attacks. In some embodiments, the drone can place or pick up the goods in the storage space near the landing pad (for example, below the lamp portion of the street light). The disclosure also provides a street light having the same and a landing pad using method.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A landing pad, comprising:
a first body comprising:
a pad portion configured for landing of a drone; and
a first coupling portion connected to the pad portion;
a second body comprising:
a mounting portion configured for mounting to a position to be mounted; and
a second coupling portion connected to the mounting portion, the second coupling portion configured for coupling with the first coupling portion;
an elastic component disposed between the first coupling portion and the second coupling portion; and
a fastening component configured for combination of the first coupling portion, the second coupling portion, and the elastic component.

2. The landing pad according to claim 1, wherein the first coupling portion and the second coupling portion comprise gears.

3. The landing pad according to claim 1, wherein the elastic component is a spring.

4. The landing pad according to claim 1, wherein the fastening component comprises a screw and a nut.

5. The landing pad according to claim 1, wherein the pad portion is functioned as a solar panel.

6. The landing pad according to claim 1, wherein the first body further comprising:
a wireless charging device disposed in or under the pad portion.

7. The landing pad according to claim 1, wherein the first body further comprising:
a securing component disposed on the pad portion, the securing component configured for fastening the drone on the pad portion.

8. The landing pad according to claim 1, wherein the second body further comprising:
an auxiliary plate disposed between the mounting portion and the second coupling portion.

9. A street light, comprising:
a pole portion;
a lamp portion connected to the pole portion; and
the landing pad according to claim 1 mounted on the lamp portion through the mounting portion.

10. The street light according to claim 8, further comprising:
a storage space below the lamp portion, the storage space provided for the drone.

11. A landing pad using method, comprising:
mounting the landing pad according to claim 1 on a lamp portion of a street light;
leveling the pad portion at an angle rotatable state of the landing pad; and
fastening the fastening component such that the landing pad is at a fixed state.

12. The landing pad using method according to claim 10, further comprising:
landing the drone on the leveled pad portion.

13. The landing pad using method according to claim 10, further comprising:
charging the drone with the landing pad.

14. The landing pad using method according to claim 10, further comprising:
charging the street light with the landing pad.
